(19) United States
(12) Patent Application Publication
(10) Pub. No.: US 2025/0021870 A1
(43) Pub. Date: Jan. 16, 2025

(54) Reliability Records Calibration and Machine Learning System for Well Facilities

(71) Applicant: HALLIBURTON ENERGY SERVICES, INC., Houston, TX (US)

(72) Inventors: Christina Marie HARRINGTON, Tulsa, OK (US); Bobby Neal ARMSTRONG, Claremore, OK (US); Travis Chet JOHNSON, Tulsa, OK (US)

(73) Assignee: HALLIBURTON ENERGY SERVICES, INC., Houston, TX (US)

(21) Appl. No.: 18/350,188

(22) Filed: Jul. 11, 2023

(51) Int. Cl. G06N 20/00

(52) U.S. Cl. CPC G06N 20/00

(57) ABSTRACT

Disclosed are systems, apparatuses, methods, and computer readable medium for calibrating data in reliability reports from a facility. A method includes: receiving a reliability report and extracting information related to operation of equipment at a facility; extracting name information associated with the facility from the reliability report; determining a full name of the facility based on the partial name; and training a machine learning model to identify conditions for equipment disposed in a well environment based on the reliability report, the unique identifier, and the full name of the facility.

### TECHNICAL FIELD

The present technology pertains to a well system for extracting materials, and more particularly, to reliability records calibration and a machine learning system for well facilities.

### BACKGROUND

A well system comprises a well-drilling system to form the well and a well-pumping system to retrieve materials from the well. A well-pumping system is a setup of equipment and machinery designed to extract natural resources, such as water, oil, or gas, from the ground. The system typically includes a drilling rig, which is used to bore a hole into the earth's crust, and a casing, which is a steel pipe that lines the well and prevents the walls from collapsing. The drilling process begins with the placement of a drill bit at the end of a drill string. The drill bit is then rotated, using a motor or a manual mechanism, to create a hole in the ground. As the hole is drilled, the drill string is gradually lengthened by adding more sections of pipe. The process continues until the desired depth is reached.

Once the drilling is complete, a casing is installed into the well to protect it from collapse and prevent contamination of the extracted resources. The casing is typically cemented into place to seal off any potential pathways for groundwater to enter the well. Once the well is prepared, a well-pumping system is installed to extract the resources from the well. The type of pump used depends on the type of resource being extracted, as well as the depth and diameter of the well. For example, a submersible pump may be used for a water well, while a reciprocating pump may be used for an oil well.

### BRIEF DESCRIPTION OF THE DRAWINGS

In order to describe the manner in which the various advantages and features of the disclosure may be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1A is a schematic diagram of an example logging while drilling (LWD) wellbore operating environment in accordance with various aspects of the disclosure;

FIG. 1B is a diagram of an example downhole environment having tubulars, in accordance with various aspects of the disclosure;

FIG. 2 illustrates a block diagram of a system for calibrating reliability data of a facility in accordance with some aspects of the disclosure;

FIG. 3 is an illustration of an example reliability report in accordance with some aspects of the disclosure;

FIG. 4 is an illustration of an example multilabel classification that may be used by a facility to identify root cause failures in accordance with some aspects of the disclosure;

FIG. 5 illustrates an example of a storage medium that stores data associated with the reliability report and may be used to mitigate adverse conditions associated with a facility in accordance with some aspects of the disclosure;

FIG. 6 illustrates an example method for calibrating reliability records in accordance with some aspects of the disclosure;

FIG. 7 is a block diagram of an example transformer in accordance with some aspects of the disclosure;

FIG. 8 is a block diagram of various encoders that may be used to identify features of unstructured documents in accordance with some aspects of the disclosure;

FIG. 9 is a block diagram of various classifiers that may be used to identify one or more classifications from one or more taxonomies in accordance with some aspects of the disclosure; and

FIG. 10 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously described, a well system (or a well site) includes a large number of interoperating components, and many of these components experience wear and tear, failure, adverse conditions, and other general issues that may affect operation of the well site. In one illustrative aspect, an electric submersible pump system, which is also referred to as an artificial lift pumping system, can be deployed into the downhole environment (e.g., into the well) and experiences high temperature, immense pressure, fluid-borne abrasives, excessive gas, scale, and variable flow rate environments. In some cases, operators of the well site may implement a records system to document operation of the various components, adverse conditions, and data related to the adverse conditions. One type of record is a reliability report that an operator of a well site fills out to identify adverse conditions and operation, and the data related to the adverse conditions may include notes pertaining to actions taken, results of those actions, and so forth. The reliability report is a collection of various notes, reports, actions, and other materials that form a summary of an operation that occur after a run, which is when equipment is inserted into the well and continues until the equipment is extracted from the well, ending the run. Reliability reports can include notes related to maintenance of equipment, diagnostic notes related to repairing an equipment that may have failed, and other diagnostic issues. For example, equipment may be dismantled, and various notes related to the state of the equipment may be entered into a maintenance or repair note. The reliability records are then entered into a data storage location (e.g., a simple file system hierarchy, a paper filing system, etc.).

In some aspects, an operating entity that operates a plurality of well sites may have this information stored, but the information associated with the well site is unstructured. For example, the information related to the operation may use short form representations of a well site. In some cases, the proper name of a well site may be hierarchal and includes geographical breakdown and an operator may write a record that omits unique identifying information of the well site. For example, a well site may have a unique name of US-TX-Alpha-011-B, which is a kebab case representation of a well site at a US location in Texas in site Alpha, district 011, and drill site B. An operator of US-TX-Alpha-011-B may not necessarily include all information when entering information into the reliability record, for example referring to the well site as “11B”. This is a conventional human error by inferring a zero does not include information, but software interprets strings and integers differently, and “11B” could arguably correspond to US-AK-Gamma-1011-B.

The reliability records cannot reliably be parsed by a parser due to human nature referring to information in shorthand form and implying some information that cannot be parsed using an imperative software parser. In addition, reliability records may include different sections that are structured or unstructured, and may also include graphical information (e.g., a chart). For example, the reliability record may include a header section that identifies objective information (e.g., a well site identifier, an operator identifier, a date, etc.). The reliability record may further include different sections such as an identification of issues, a general notes section, a conclusion, and so forth. In addition to the document variation and shorthand form in the notes, the reliability records may be incomplete and omit sections.

The disclosed technology addresses the foregoing by using a machine learning system to calibrate the reliability data and merge the reliability data into the information extracted using one or more machine learning models. In some aspects, the disclosed technology may implement a natural language processor (NLP) using, for example, a transformer model, to identify key phrases using state-of-the-art techniques to extract information from the unstructured content in the reliability records. In some cases, the unstructured information may be used to train a machine learning model (e.g., a neural network) to perform tasks such as classifying information, identifying concepts, and so forth.

In various embodiments, A system may include one or more processors and at least one computer-readable storage medium storing instructions which, when executed by the one or more processors, cause the one or more processors to receive a reliability report and extract information related to reliability of equipment from a facility; extract a partial name associated with the facility from the reliability report; determine a full name of the facility based on the partial name; and train a machine learning model based on the reliability report, the unique identifier, and the full name of the facility. In some aspects, the instructions may perform a fuzzy match and use various information from the reliability report to identify a uniquely identifying full name of the facility. The full name of the facility is mapped to information in the reliability report, and a machine-learning model is trained based on the reliability report. In some cases, many reliability reports of various equipment at a facility may be available, and based on the cumulative information from different facilities in the same and different geographical locations may be used to train a machine learning model to mitigate operational failures at the facilities.

Additional details and aspects of the present disclosure are described in more detail below with respect to the figures.

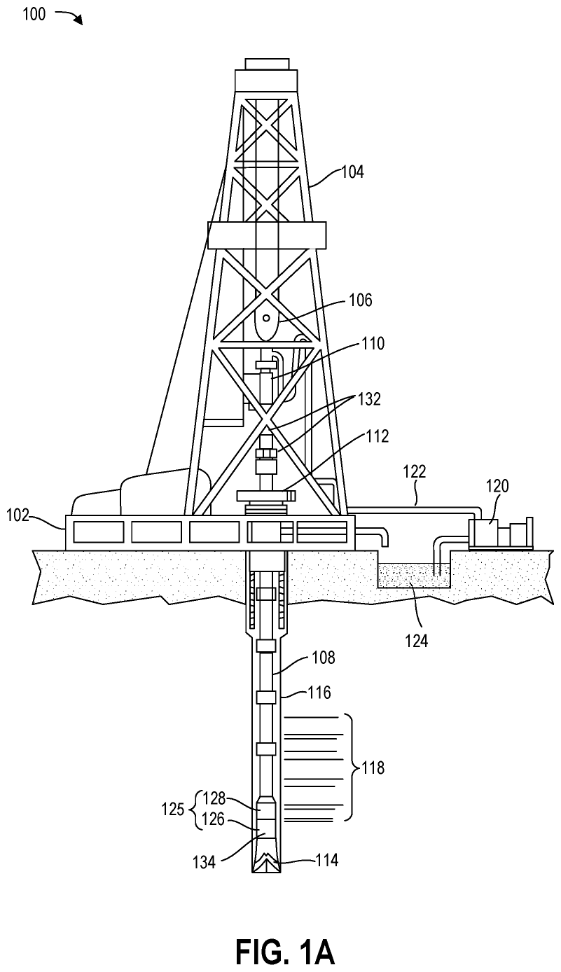

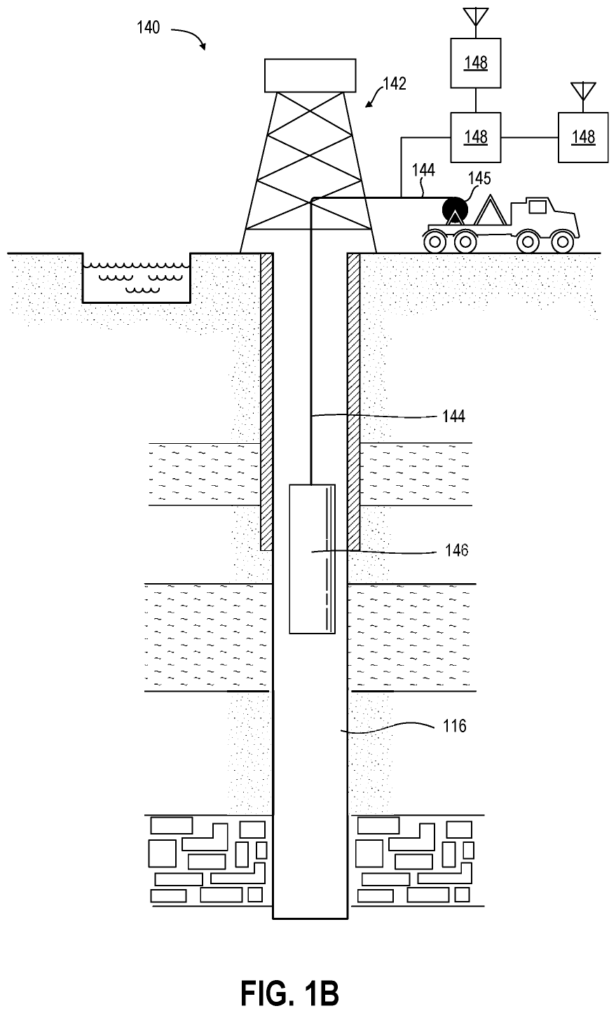

FIG. 1A is a schematic diagram of an example logging while drilling (LWD) operating environment of a well site, in accordance with various aspects of the disclosure.

In some aspects, a drilling arrangement is shown that exemplifies a LWD configuration in a wellbore drilling scenario 100. The LWD typically incorporates sensors that acquire formation data. The drilling arrangement of FIG. 1A also exemplifies measurement while drilling (MWD) and utilizes sensors to acquire data from which the wellbore's path and position in three-dimensional space may be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 may be connected to the lower end of the drill string 108. As the drill bit 114 rotates, the drill bit 114 creates a wellbore 116 that passes through one or more subterranean formations 118. A pump 120 circulates drilling fluid through a supply pipe 122 to top drive 110, down through the interior of the drill string 108, and out orifices in the drill bit 114 into the wellbore. The drilling fluid returns to the surface via the annulus around the drill string 108, and into a retention pit 124. The drilling fluid transports cuttings from the wellbore 116 into the retention pit 124 and the drilling fluid's presence in the annulus aids in maintaining the integrity of the wellbore 116. Various materials may be used for drilling fluid, including oil-based fluids and water-based fluids.

In some aspects, one or more logging tools 126 may be integrated into the bottom-hole assembly 125 near the drill bit 114. As the drill bit 114 extends the wellbore 116 through the subterranean formations 118, logging tools 126 collect measurements relating to various formation properties as well as the orientation of the tool and various other drilling conditions. In some cases, the logging tools interface with various sensors and equipment. The bottom-hole assembly 125 may also include a telemetry sub 128 to transfer measurement data to a surface receiver 132 and to receive commands from the surface. In at least some cases, the telemetry sub 128 communicates with a surface receiver 132 using mud pulse telemetry. In some instances, the telemetry sub 128 does not communicate with the surface, but rather stores logging data for later retrieval at the surface when the logging assembly is recovered.

Each of the logging tools 126 may include one or more tool components spaced apart from each other and communicatively coupled by one or more wires and/or another communication arrangement. The logging tools 126 may also include one or more computing devices communicatively coupled with one or more of the tool components. The one or more computing devices may be configured to control or monitor the performance of the tool, process logging data, and/or carry out one or more aspects of the methods and processes of the present disclosure.

In at least some instances, one or more of the logging tools 126 may communicate with a surface receiver 132 by a wire, such as a wired drill pipe. In other cases, the one or more of the logging tools 126 may communicate with a surface receiver 132 by wireless signal transmission, such as ground penetrating radar. In at least some cases, one or more of the logging tools 126 may receive electrical power from a wire that extends to the surface, including wires extending through a wired drill pipe.

In some aspects, a collar 134 is a frequent component of a drill string 108 and generally resembles a very thick-walled cylindrical pipe, typically with threaded ends and a hollow core for the conveyance of drilling fluid. In some cases, multiple collars 134 may be included in the drill string 108 and are constructed and intended to be heavy to apply weight on the drill bit 114 to assist the drilling process. Because of the thickness of the collar's wall, pocket-type cutouts or other type recesses may be provided into the collar's wall without negatively impacting the integrity (strength, rigidity, and the like) of the collar 134 as a component of the drill string 108.

FIG. 1B is a diagram of an example downhole environment having tubulars in accordance with various aspects of the disclosure. In some aspects, an example system 140 is depicted for conducting downhole measurements after at least a portion of a wellbore has been drilled and the drill string removed from the well. A downhole tool is shown having a tool body 146 to perform logging, measurements, and/or other operations. For example, instead of using the drill string 108 of FIG. 1A to lower a tool body 146, which may contain sensors and/or other instrumentation for detecting and logging nearby characteristics and conditions of the wellbore 116 and surrounding formations, a wireline conveyance 144 may be used.

The tool body 146 may be lowered into the wellbore 116 by wireline conveyance 144. The wireline conveyance 144 may be anchored in the drill rig 142 or by a portable device such as a truck 145. The wireline conveyance 144 may include one or more wires, slicklines, cables, and/or the like, as well as tubular conveyances such as coiled tubing, joint tubing, or other tubulars.

The wireline conveyance 144 provides power and support for the tool, as well as enabling communication between processing systems 148 on the surface. In some examples, the wireline conveyance 144 may include electrical and/or fiber optic cabling for performing any communications. The wireline conveyance 144 is sufficiently strong and flexible to tether the tool body 146 through the wellbore 116, while also permitting communication through the wireline conveyance 144 to one or more of the processing systems 148, which may include local and/or remote processors. In some cases, power may be supplied via the wireline conveyance 144 to meet the power requirements of the tool. For slickline or coiled tubing configurations, power may be supplied downhole with a battery or via a downhole generator.

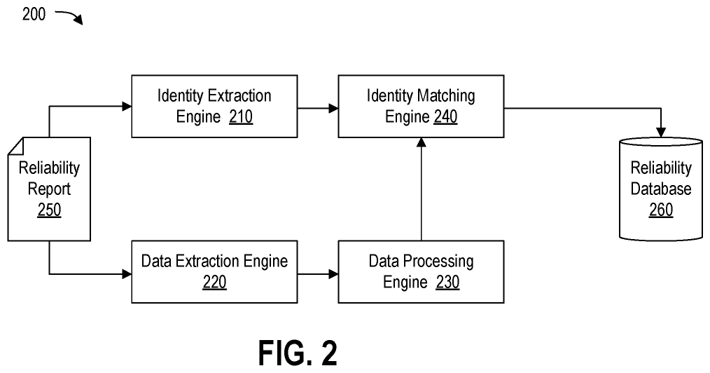

FIG. 2 illustrates a block diagram of a system for calibrating reliability data of a facility in accordance with some aspects of the disclosure. In one aspect, the facility may be a well site for extracting subterranean materials (e.g., liquids). Other non-limiting examples of a facility include a facility for extracting or processing solid minerals, an educational facility, a commercial facility, a semiconductor manufacturing facility, a chemical processing facility, an agricultural facility, and so forth.

In one aspect, an example system 200 includes an identity extraction engine 210, a data extraction engine 220, a data processing engine 230, and an identity machine engine 240. In some aspects, the system 200 is configured to perform the functions described below based on reliability report 250 and store data in a reliability database 260.

In some aspects, the reliability report is provided to the identity extraction engine 210 and the identity extraction engine 210, with the identity extraction engine 210 being configured to identify identity information associated with a facility corresponding to the reliability report 250. In some cases, the reliability report 250 may include partial information that does not uniquely identify the facility. For example, a person enters the information into an application that generates the reliability report 250 or enters the information into the reliability report 250, but only identifies a portion of the facility's unique identity. For example, as noted above, a person may refer to the facility as “111B”, which a person reading the report would implicitly understand as US-TX-Alpha-011-B in some cases. However, a computing system is unable to distinguish 11B from 1011-B, 011.B, and so forth. In this case, the identity extraction engine 210 may identify other information to assist in identifying the facility, such as the location of the report or any other tangential information that could assist in inferring the identity of the facility.

In addition, the reliability report 250 is also provided to the data extraction engine 220 for extraction of at least a portion of the reliability report 250. In one aspect, the data extraction engine 220 is configured to extract content (e.g., from documents in various electronic formats), parse the data within the reliability report, and clean the data using various techniques. In one aspect, the data extraction engine 220 may identify at least one section associated with the reliability report 250 and then identify objects, concepts, and other useful information within the unstructured text of the reliability report 250. In one illustrative aspect, the data extraction engine 220 may identify n-grams, which is an NLP term for at least one word that relates to a singular concept. For example, an adjective and noun combination is an n-gram. In other examples, an n-gram may be a combination of nouns or adjectives (e.g., transmission device, scheduling information, etc.), include quantifiers (e.g., one or more items), and prepositional phrases (e.g., a set of devices), and other grammatical concepts. In some cases, the data extraction engine 220 may identify a stem associated with the n-grams. A stem is a base form of a term and generally corresponds to a space in non-Euclidean vector space that may be used to identify related concepts. For example, the stem of a transmitter and a stem of a sender would be near each other because both terms have related meanings.

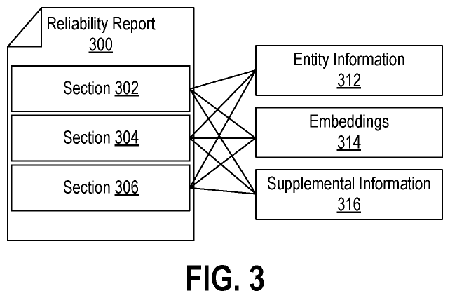

In some aspects, the data extraction engine 220 may also be configured to classify one or more concepts. One illustrative aspect of the data extraction engine 220 comprises extracting n-grams in combination with other grammatical clues (e.g., the verb, the object of the verb, etc.). The data extraction engine 220 may also identify entities using a named entity recognition (NER) model. The NER is configured to identify and classify different named entities in a text into predefined categories such as person names, organizations, locations, medical codes, time expressions, quantities, monetary values, error codes, percentages, etc. In some cases, the NER is trained using a specific dataset, such as a dataset associated with a well site to identify terms and concepts specific to the well site. The data extraction engine 220 may also generate embeddings, which are vector representations of a word (or n-grams) in non-Euclidean space with many dimensions. Examples of embeddings are further described with reference to FIG. 3.

The extracted data from the data extraction engine 220 is provided to the data processing engine 230 to process the data and identify various classifications and other concepts. The classifications may be binary, either indicating the presence of a quality (e.g., is the message a spam message) or multi-label, which identifies a finite number of classifications (e.g., a type of vehicle). An example of a binary classification is generally confidence of a true or false value, such as whether a device is operating within a normal operating range or a fault range. An example of a multilabel classifier is a confidence of multiple possible classifications, such as a type of subterranean material that a drill is drilling into, and so forth.

In some aspects, the data processing engine 230 may include multiple classifiers related to operation of various equipment within the facility. For example, the data processing engine 230 may include at least one binary classifier for each equipment. In some cases, as noted above, data pertaining to each equipment may not be available because the equipment may be within the wellbore and the data processing engine 230 may be configured to generate inferences related to this equipment during runtime operation. In some cases, some inferences may be required to complete a reliability report, such as if the serial number of an equipment is not available.

In some cases, the results of the data processing engine 230 and the identity extraction engine 210 are provided to the identity matching engine 240 which performs a match to identify a unique identifier associated with the facility where the equipment was installed. For example, in some cases, the identity machine engine 240 may include a fuzzy match algorithm to identify at least one candidate facility. In other cases, the identity machine engine 240 may use the entities identified in the data extraction engine 220 to narrow geolocation of the fuzzy match algorithm. In some cases, the reliability report 250 may include metadata (e.g., a header of the document), named entities (e.g., a city, a person, etc.), and other clues that the identity machine engine 240 may use to limit the scope of the fuzzy match. The identity machine engine 240 identifies the unique information corresponding to the facility and associates all information extracted in the data extraction engine 220 and the data processing engine 230 with the unique information.

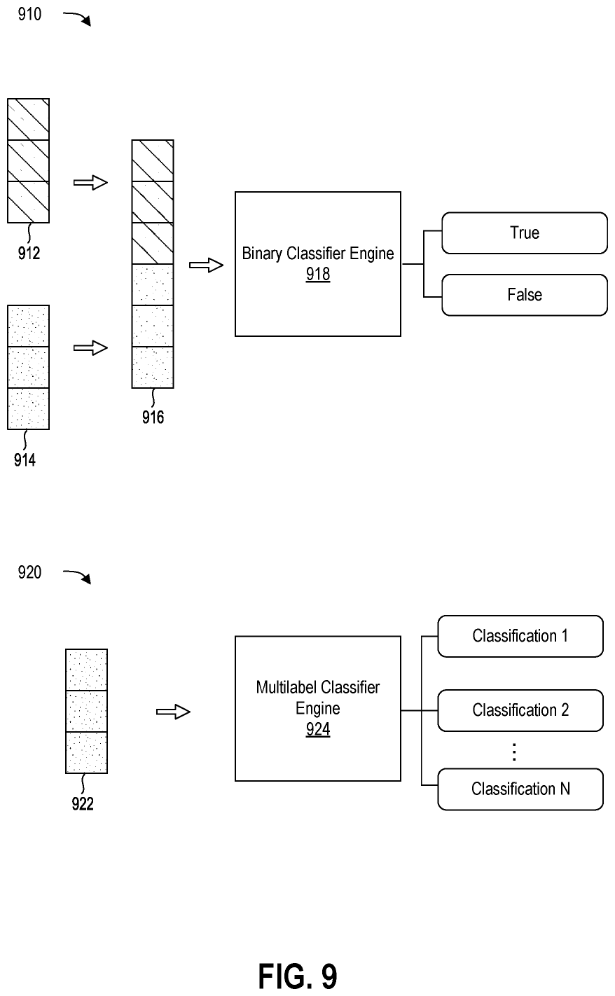

FIG. 3 is an illustration of an example reliability report in accordance with some aspects of the disclosure. In some aspects, the reliability report 300 includes different sections, such as a first section 302, a second section 304, and a third section 306. In one aspect, the first section 302 may identify an adverse condition at a well site (such as the wellbore drilling scenario 100), a second section 304 may identify different attempts to resolve the adverse condition, and the third section 306 may provide recommendations. In some aspects, the reliability report may include known sections that may be identified using a classifier (e.g., such as the binary classifier engine 918 or the multilabel classifier engine 924 in FIG. 9). In other cases, the reliability report may vary over time based on evolving requirements of a well operator, and the different classifications may encompass all variations. For example, a regulator requirement may dictate the creation of a section within the reliability report.

According to aspects of the disclosure, data may be extracted to include various information that may be combined in different manners to enable a well operator to synthesize all reliability reports, irrespective of human variation that is introduced into these reports. In one aspect, each reliability report may be mined for entity information 312, which includes identifying and classifying named entities in a text into predefined categories such as person names, organizations, locations, medical codes, time expressions, quantities, monetary values, error codes, percentages, etc. In some cases, NER may be performed using an existing model (e.g., identification of names, and dates) but may also be custom trained based on the context of the NER. For example, the well operator may train a NER model to identify various entities (e.g., businesses, equipment names, people) associated with the well site, compound names, chemicals, issues, and so forth.

In some cases, the entity information 312 can be used to identify location to assist in identification of a unique name for the facility. As further described below, the reliability report may include partial information that identifies the facility. In some cases, a machine learning model can use a location as a parameter to learn parameters that group reliability reports to similar inferences. For example, wells operating in different geographic regions may experience different conditions such as temperature, materials, etc. Entity information, such as the presence of materials, the temperature, and other factors identified by a NER model can assist in identifying a geographical region associated with the facility.

In addition, a machine learning system may extract the embeddings 314 associated with the reliability report 300. In this case, the machine learning system transforms a word or words into vectors in non-Euclidean space represented by many dimensions (e.g., hundreds) that captures semantics associated with the word into different groups. In some cases, words may also have higher attention value and lower attention value and meanings may be extrapolated based on the attention value. For example, stop words (e.g., a determiner such as “the” and “an”) have a lower attention value.

In further aspects, the machine learning system may also extract supplemental information 316, which includes any other information to support content with the reliability report 300. Non-limiting examples of the third section 306 include graphs, bitmap images, semi-structured content (e.g., tables), structured data inline with unstructured text (e.g., a sentence including an array in text form such as [0, 1, 3]), etc.

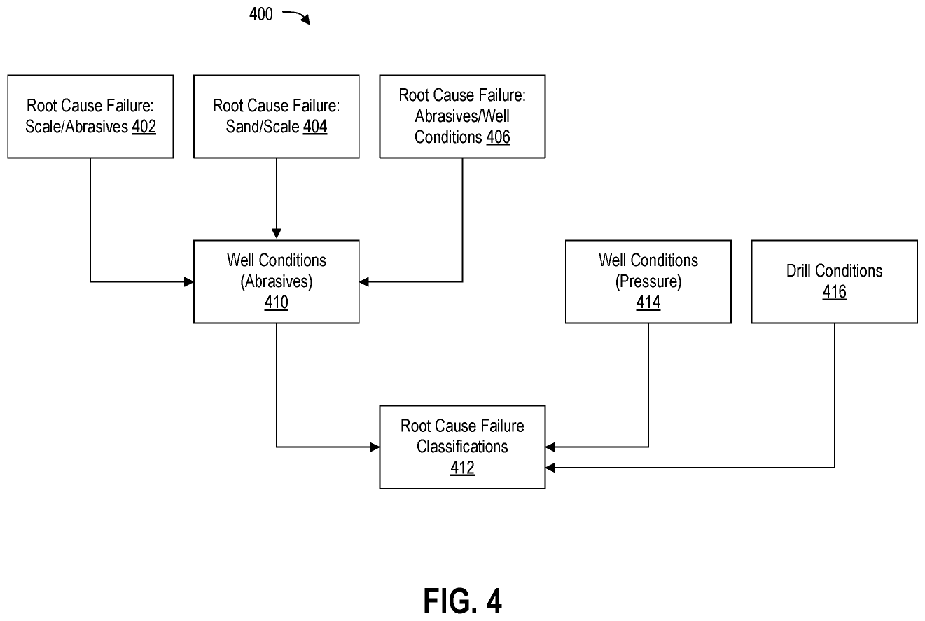

FIG. 4 is an illustration of an example multilabel classification 400 that may be used by a facility to identify root cause failures in accordance with some aspects of the disclosure.

In some aspects, a machine learning system may identify a plurality of properties associated with the unstructured text, such as the presence of various abrasives, materials, and effects resulting from the materials, and identify various classifications. In some aspects, the volume of reliability reports and the generation of root cause failures is untenable by manual operation and the machine learning system may be configured to identify classifications, and groups associated with the classifications.

As an example, the multilabel classification 400 may identify the presence of fluid-borne abrasives and scale that abrasively affects equipment, thereby creating a scale/abrasives label 402. In some cases, the label may be more specific by identifying the material. As an example, the multilabel classification 400 may also identify the presence of sand that causes failure of that item as denoted by the sand/scale label 404. The multilabel classification 400 may also note that the well conditions induced by the presence of abrasives cause item failure as denoted by the abrasives/well conditions 406 label.

In some cases, the machine learning system may group the identified labels using a common pattern identified in the reliability reports using a higher-order abstraction. For example, the machine learning system may assign each of the scale/abrasives label 402, the sand/scale label 404, and the abrasives/well conditions 406 to a well condition (abrasives) label 410, which is a member of the root cause failure classifications 412. As illustrated in FIG. 4, the root cause failure classifications 412 may include other classifications, such as a well conditions (pressure) label 414 that is related to pressure conditions within the well, or drill conditions 416. In some aspects, the classifications can include types of classifications, such as identifications of defects, extenuating circumstances, adverse environments, design limitations, operation errors, degradation, and so forth.

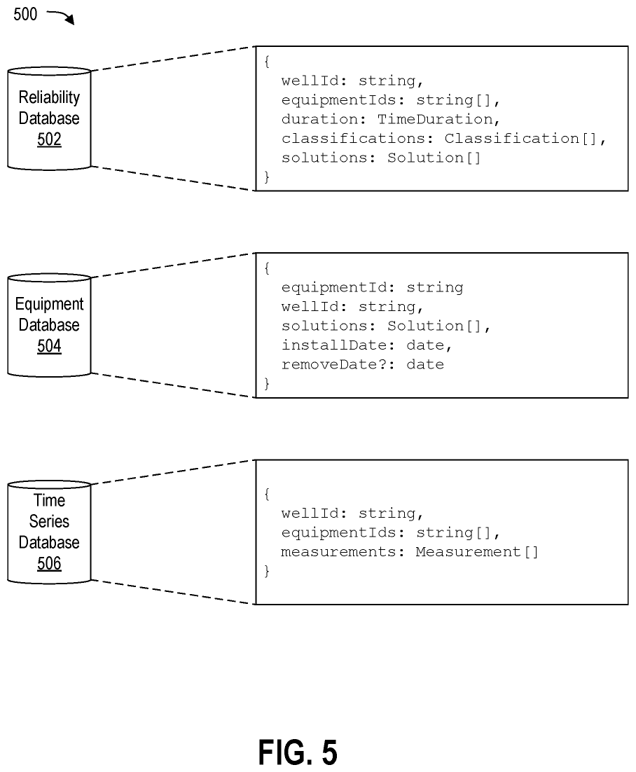

FIG. 5 illustrates an example of a storage medium 500 that stores data associated with the reliability report and may be used to mitigate adverse conditions associated with a facility in accordance with some aspects of the disclosure. In some aspects, the storage medium 500 includes a plurality of logical storage groups, such as reliability database 502, equipment database 504, and time series database 506.

In one aspect, the reliability database 502 is configured to store reliability information that is extracted from the reliability reports and may be structured into a normalized database (e.g., a normalized database such as structured query language (SQL)) or a schema-free document database. In some aspects, the extracted information from the reliability report is illustrated in JavaScript Object Notation (JSON) with a name of a field and a corresponding type. As shown in FIG. 5, each record of the reliability database 502 may include a well identifier (wellId) that identifies the well, at least one equipment installed (equipmentIds), a duration associated with the report (duration), various classifications (classifications), and various responses based on the well conditions and equipment parameters. In this case, a field ending with Id and having a type of string is a reference to another object and may be referred to as a primary key, unique identifier, and so forth.

In some aspects, the storage medium 500 may also store equipment within the equipment database 504 and include an equipment identifier (e.g., equipmentId), a corresponding well (e.g., identified by welId), responses (e.g., identification of corresponding actions taken in response to well or other operating conditions), an install date, and an optional field that indicates whether the equipment is removed (e.g., the optional removeDate). In some aspects, the equipment database 504 may be used to build time series data related to the reliability database 502 in connection with the training of a machine learning model to mitigate adverse conditions during the runtime operation of the facility. For example, the machine learning model may identify adverse conditions of a well site based on detected conditions (e.g., materials, pressure, etc.).

In some cases, the time series database 506 may be generated in real-time based on real-time measurements associated with equipment. For example, at least one equipment at the facility may detect data and populate the time series database 506 based on measurements from that equipment and identify various information. In one illustrative example, the time series database 506 may be a cloud-based database that is connected to the facility, and each facility is configured to collect data and report the collected data at a regular schedule and/or events. In one aspect, the time series database 506 may store, for example, a well identifier (e.g., wellId), a list of equipment identifiers (e.g., equipmentIds), and a plurality of measurements associated with the various equipment at that facility. In some cases, each record in the time series database 506 is inherently associated with a time, and the collected measurements are recorded based on the time. In some case, the various measurements of an equipment are available after runtime, and the time series database 506 may receive the measurements and propagate the measurements into the time series database.

In this case, the reliability database 502, the equipment database 504, and the time series database 506 calibrate the data in various ways such that data may be used to train a machine learning model or provide federated learning to a machine learning model, thereby tuning the parameters of the machine learning model based on the subsequent run information.

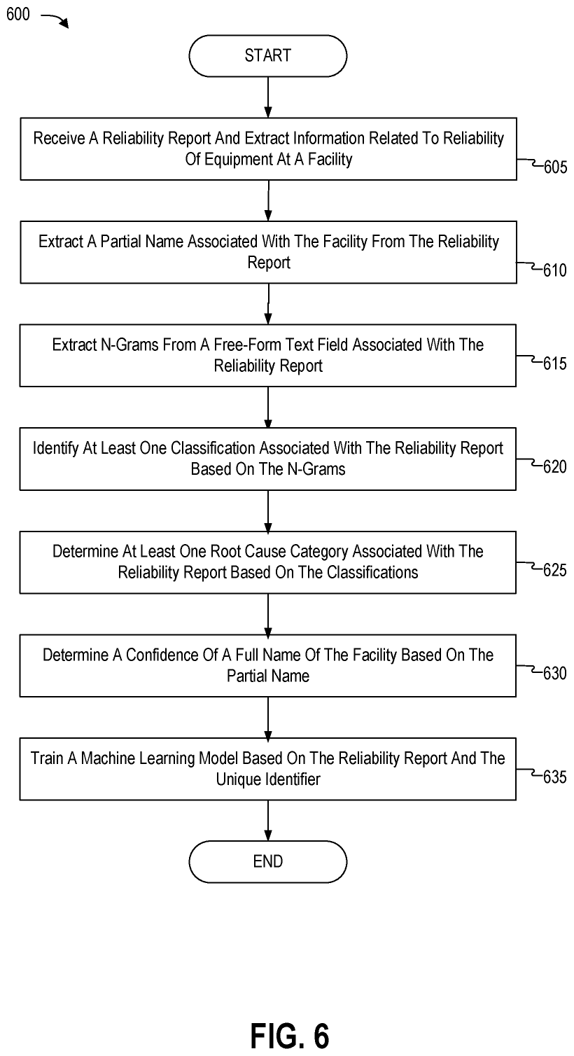

FIG. 6 illustrates an example method 600 for calibrating reliability records in accordance with some aspects of the disclosure. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

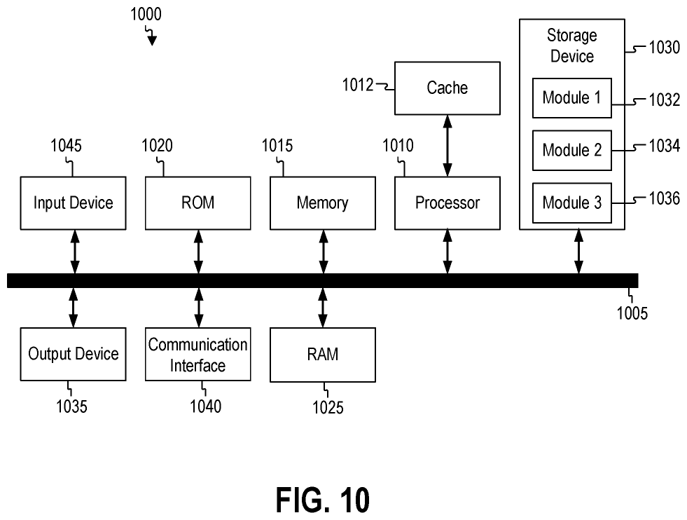

According to some examples, a computing system (e.g., the computing system 1000 of FIG. 10) may receive a reliability report and extract information related to reliability of equipment from a facility. In one illustrative example, the facility comprises a drilling site associated with a well. For example, the drilling site may be configured to extract minerals from beneath the earth. In some cases, equipment of the facility may communicate with the computing system 1000 during runtime and other equipment may record runtime information but cannot communicate with the computing system.

At block 610, the computing system may extract a partial name associated with the facility from the reliability report at block 610. For example, the reliability report may be authored by a person and use short-form or shorthand information that identifies the facility.

At block 615, the computing system may extract n-grams from a free-form text field associated with the reliability report. For example, the reliability report may include a plurality of sections that enable an operator of the facility to provide a narrative description (e.g., unstructured text).

At block 620, the computing system may identify at least one classification associated with the reliability report based on the n-grams. Each classification may be associated with a root cause associated with an operational issue of the facility. For example, the classification may identify conditions associated with operation of the facility. In the case of a well site, the computing system may identify at least one factor that is associated with the operational issue, such as the presence of one or more abrasive materials within a well, the presence of pressure within the well, and so forth.

In some cases, the computing system may also determine a classification associated with the reliability report. For example, the reliability records may be extensive, and a classification for each scenario may be impractical to assemble. In this case, the computing system may implement a vectorization to enable the creation of classifications while calibrating the reliability records.

In some aspects, the computing system may also identify at least one remediating action taken. For example, the reliability report may include a section corresponding to different attempts to resolve the scenario, and these sections may include at least one remediating action taken by the operator.

At block 625, the computing system may determine at least one root cause category associated with the reliability report based on the classifications. In some cases, the determining of the at least one root cause may use remediation attempts taken by the operator to identify the at least one root cause. For example, a machine learning model can learn parameters from past reliability reports with similar parameters associated with time series data to identify different classifications. During runtime operation, the machine learning model can classify the runtime operation based on the learned parameters and trigger a classification associated with the equipment. Based on the classification, an operator of the facility can then take a corrective action to prevent adverse conditions that may affect the equipment or the operation at the facility.

In one aspect of block 625, the computing system may identify at least one response corresponding to the at least one root cause based on the n-grams. In some cases, various techniques may be used to identify various responses to the issue. For example, the reliability report may include a section specifically dedicated to the final remedy. In some cases, the computing system may classify this section as a response, process the n-grams, and classify the response using a classifier.

In one aspect of block 625, the computing system may identify an equipment associated with at least one of the response or the root cause based on the unique identifier of the facility. In some cases, records associated with the facility may be available and the computing system may use these records to surface information that identifies the one or more potential causes of the failure.

At block 630, the computing system may determine confidence of a full name of the facility based on the partial name. The full names include at least a portion of partial name. However, the partial names may match at least one other full name and therefore the partial name cannot uniquely identify the identity of the facility alone. In some cases, a fuzzy matching algorithm using information from the reliability record may restrict different parameters and more concretely identify the correct full name of the facility. In one example, the computing system may identify each facility that matches the partial name along with a confidence. As described above, information pertaining to equipment at the facility is stored in a data source based on a full name of the facility, reliability reports and unstructured information associated with the facility are stored in the data source based on the full name, and time series data associated with measurements from the equipment at the facility stored in the data source include the full name. In some cases, the full name may be correlated to a unique identifier (e.g., a universal unique identifier (UUID)).

At block 635, the computing system may train a machine learning model based on the reliability report and the unique identifier. The machine learning model is configured to receive runtime information, identify at least one condition based on the runtime information, and identify at least one alert related to the at least one condition. In one aspect, the alert may be related to an adverse condition and corrective actions corresponding to the adverse condition. In other cases, the alert may be a warning to notify an operator to monitor at least one parameter. In some cases, the machine learning model is executed during runtime of the facility and may be used to identify or infer adverse conditions. As an example, a first equipment may be unable to communicate with the surface equipment, and the machine learning model may be able to infer adverse conditions associated with the first equipment based on the previous reliability reports.

The machine learning model can also be used to perform predictive tasks to assist in various functions of well operation, including well drilling operations and well pumping operations. In one illustrative example, the machine learning model can identify equipment for a future installation, size equipment for a future installation based on different parameters, and so forth. Well diagnostics using the machine learning model can develop an understanding of the equipment at runtime operations and identify relationships with external factors, such as well conditions, to optimize performance and maximize production.

In some cases, the computing system may also supplement training of a machine learning model (e.g., federated learning) based on additional reliability reports and other information surfaced after the initial training.

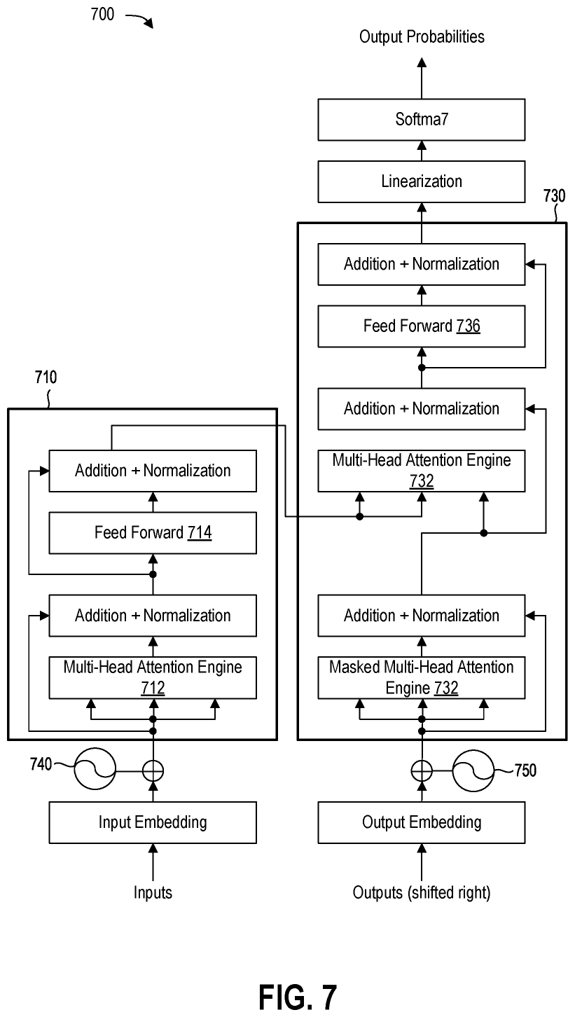

FIG. 7 is a block diagram of an example transformer in accordance with some aspects of the disclosure.

In a convolutional neural network (CNN) model, the number of operations required to relate signals from two arbitrary input or output positions grows in the distance between positions, which makes learning dependencies at different distant positions challenging for a CNN model. A transformer 700 reduces the operations of learning dependencies by using an encoder 710 and a decoder 730 that implement an attention mechanism at different positions of a single sequence to compute a representation of that sequence. An attention function may be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 710 is composed of a stack of six identical layers and each layer has two sub-layers. The first sub-layer is a multi-head self-attention engine 712, and the second sub-layer is a fully connected feed-forward network 714. A residual connection (not shown) connects around each of the sub-layers followed by normalization.

In this example transformer 700, the decoder 730 is also composed of a stack of six 6 identical layers. The decoder also includes a masked multi-head self-attention engine 732, a multi-head attention engine 734 over the output of the encoder 710, and a fully connected feed-forward network 736. Each layer includes a residual connection (not shown) around the layer, which is followed by layer normalization. The masked multi-head self-attention engine 732 is masked to prevent positions from attending to subsequent positions and ensures that the predictions at position i may depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 740 to encode positions because the model does not contain recurrence and convolution and relative or absolute position of the tokens is needed. In the transformer 700, the positional encodings are added to the input embeddings at the bottom layer of the encoder 710 and the decoder 730. The positional encodings are summed with the embeddings because the positional encodings and embeddings have the same dimensions. A corresponding position decoder 750 is configured to decode the positions of the embeddings for the decoder 730.

In some aspects, the transformer 700 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 700 may process input sequences of variable length, making it well-suited for natural language processing tasks where input lengths may vary greatly. Additionally, the self-attention mechanism allows the transformer 700 to capture long-range dependencies between words in the input sequence, which is difficult for recurrent neural networks (RNNs) and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

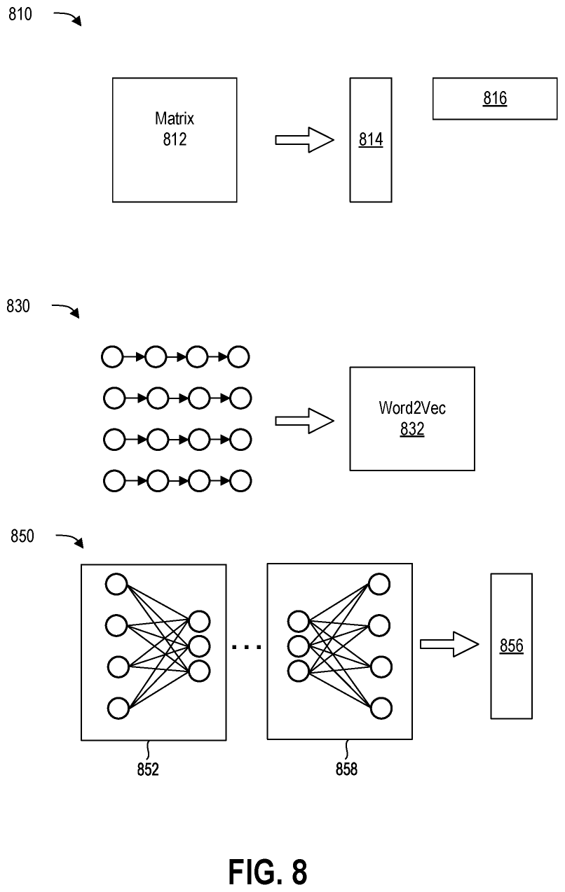

FIG. 8 is a block diagram of various encoders that may be used to identify features of unstructured documents in accordance with some aspects of the disclosure. In particular, FIG. 8 includes a block diagram of a matrix encoder 810, a random walk encoder 830, and a neural network encoder 850.

The matrix encoder 810 identifies the most important features of data (e.g., most important embeddings) and reduces the features into a lower dimensional representation. Non-limiting examples of techniques incorporated into the matrix encoder 810 include singular value decomposition (SVD), principal component analysis (PCA), or autoencoders to perform the transformation. For example, the matrix encoder 810 converts a matrix 812 into a column 814 of components and a row 816 of features associated with the components. The lower-dimension representation of the matrix 812 may be used to assist in clustering, classification, and visualization, as well as improve the efficiency of computations.

The random walk encoder 830 simulates a random walk process on graphs or networks to generate sequences of node visits that are used as input into a neural network, such as word2vec 832 to produce a word embedding. The random walk process involves starting at a randomly chosen node in the graph and moving to a neighboring node at each step according to a certain probability distribution. By repeating this process for multiple iterations, a sequence of node visits is generated for each starting node. These sequences are then used as the input data.

The neural network encoder 850 is a trained neural network that has learned mappings between a high-dimensional input into a lower-dimensional space. The neural network encoder 850 includes an encoder and may include a decoder. Each encoder of the neural network encoder 850 includes several layers of artificial neurons that perform a non-linear transformation on the input data and reduce high-dimensional data to lower data by learning based on various techniques, such as backpropagation. The neural network encoder may be trained using various optimization techniques to minimize a loss function that measures the difference between the original high-dimensional data and the reconstructed data. The neural network encoder 850 provides flexibility and ability to learn complex and non-linear mappings between the input data and the encoding result but requires large amounts of training data, computational resources, and careful tuning of the network architecture and hyperparameters.

The matrix encoder 810, the random walk encoder 830, and the neural network encoder 850 each have advantages and disadvantages. The matrix encoder 810 is computationally efficient and may handle large datasets but may not be as effective in capturing semantic information or feature interactions. The random walk encoder 830 is effective in capturing structural information and node similarities in graphs but may not be suitable for other types of data. The neural network encoder 850 is flexible and may learn complex mappings between the input data and the encoding but may require large amounts of training data and computational resources.

FIG. 9 is a block diagram of various classifiers that may be used to identify one or more classifications from one or more taxonomies in accordance with some aspects of the disclosure. In particular, FIG. 9 includes a binary classifier 910 and a multilabel classifier 950.

The binary classifier 910 is configured to classify data into two categories that is generally represented by true or false. An example of a binary classification includes a classification of an email as spam or not spam. Other examples of binary classification include sentiment analysis (e.g., positive review or negative review) and fraud detection.

One example of a binary classifier includes concatenating a first embedding 912 and a second embedding 914 into a summed embedding 916 and then executing a binary classifier engine 918, which determines whether the summed embedding 916 corresponds to a characteristic that the binary classifier engine 918 is trained to detect.

A multilabel classifier 920 is configured to classify data into multiple categories or labels, where each example may belong to more than one label. The classifier is trained using a labeled dataset, where each example is associated with a set of binary labels. The classifier then learns a decision boundary for each label in the input space. An example of a multilabel classifier includes a color classification (e.g., red, green, etc.), a music genre classification, a car type, etc. The multilabel classifier 920 is effective in capturing the complex relationships and dependencies among the labels, as well as handling imbalanced and overlapping label distributions.

An example of a binary classifier includes inputting an embedding 922 into a multilabel classifier engine 924, which analyzes the embedding based on trained data to identify the corresponding classification (e.g., color, type, etc.).

In some aspects, the binary classifier 910 and the multilabel classifier 920 may be implemented at various points of the machine learning system and may be used to determine the clustering of various embeddings, classifications, and so forth.

FIG. 10 is a diagram illustrating an example of a system for implementing certain aspects of the present technology. In particular, FIG. 10 illustrates an example of computing system 1000, which may be for example any computing device making up an internal computing system, a remote computing system, a camera, or any component thereof in which the components of the system are in communication with each other using connection 1005. Connection 1005 may be a physical connection using a bus, or a direct connection into processor 1010, such as in a chipset architecture. Connection 1005 may also be a virtual connection, networked connection, or logical connection.

In some aspects, computing system 1000 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 1000 includes at least one processing unit (CPU or processor) 1010 and connection 1005 that couples various system components including system memory 1015, such as ROM 1020 and RAM 1025 to processor 1010. Computing system 1000 may include a cache 1012 of high-speed memory connected directly with, in close proximity to, or integrated as part of processor 1010.

Processor 1010 may include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which may represent any number of input mechanisms, such as a microphone for speech, a touch-sensitive screen for gesture or graphical input, keyboard, mouse, motion input, speech, etc. Computing system 1000 may also include output device 1035, which may be one or more of a number of output mechanisms. In some instances, multimodal systems may enable a user to provide multiple types of input/output to communicate with computing system 1000. Computing system 1000 may include communications interface 1040, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning@ port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 may include software services, servers, services, etc., that when the code that defines such software is executed by the processor 1010, it causes the system to perform a function. In some aspects, a hardware service that performs a particular function may include the software component stored in a computer-readable medium in connection with the necessary hardware components, such as processor 1010, connection 1005, output device 1035, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device may be implemented in circuitry. For example, the components may include and/or may be implemented using electronic circuits or other electronic hardware, which may include one or more programmable electronic circuits (e.g., microprocessors, GPUs, DSPs, CPUs, and/or other suitable electronic circuits), and/or may include and/or be implemented using computer software, firmware, or any combination thereof, to perform the various operations described herein.

In some aspects the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures may include hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein may be replaced with less than or equal to (“<”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of calibrating reliability records, comprising: receiving a reliability report and extracting information related to operation of equipment at a facility; extracting name information associated with the facility from the reliability report; determining a full name of the facility based on the name information; and training a machine learning model based on the reliability report, the unique identifier, and the full name of the facility.

Aspect 2. The method of Aspect 1, wherein the unique identifier includes the name information, and wherein the name information matches at least one other unique identifier.

Aspect 3. The method of any of Aspects 1 to 2, wherein extracting the information related to the operation of the equipment at the facility: extracting n-grams from a free-form text field associated with the reliability report; classifying the operation of the facility based on the n-grams into at least one classification; and determining at least one root cause associated with an equipment at the facility based on the at least one classification.

Aspect 4. The method of any of Aspects 1 to 3, wherein the at least one classification is associated with a root cause associated with an operational issue of the equipment.

Aspect 5. The method of any of Aspects 1 to 4, wherein the facility comprises a well pumping system configured to extract materials from a downhole of a well.

Aspect 6. The method of any of Aspects 1 to 5, wherein the machine learning model is configured to infer operations of a well drilling system at the facility.

Aspect 7. The method of any of Aspects 1 to 6, further comprising: identifying a response corresponding to the at least one root cause based on the n-grams.

Aspect 8. The method of any of Aspects 1 to 7, identifying an equipment associated with at least one of the response or the root cause based on the unique identifier of the facility.

Aspect 9. The method of any of Aspects 1 to 8, wherein the machine learning model is configured to receive runtime information, identify at least one condition based on the runtime information, and output a notification related to the at least one condition.

Aspect 10. The method of any of Aspects 1 to 9, wherein the full name comprises a unique identifier, information pertaining to equipment at the facility is stored in a data source and includes the unique identifier, reliability reports and unstructured information associated with the facility and stored in the data source include the unique identifier, and time series data associated with measurements from the equipment at the facility stored in the data source include the unique identifier.

Aspect 11. A system for calibrating reliability records includes a storage (implemented in circuitry) configured to store instructions and a processor. The processor configured to execute the instructions and cause the processor to: receive a reliability report and extract information related to operation of equipment at a facility; extract name information associated with the facility from the reliability report; determine a full name of the facility based on the name information; and train a machine learning model based on the reliability report, the unique identifier, and the full name of the facility.

Aspect 12. The system of Aspect 11, wherein the unique identifier includes the name information, and wherein the name information matches at least one other unique identifier.

Aspect 13. The system of any of Aspects 11 to 12, wherein extracting the information related to the operation of the equipment at the facility: extract n-grams from a free-form text field associated with the reliability report; classify the operation of the facility based on the n-grams into at least one classification; and determine at least one root cause associated with an equipment at the facility based on the at least one classification.

Aspect 14. The system of any of Aspects 11 to 13, wherein the at least one classification is associated with a root cause associated with an operational issue of the equipment.

Aspect 15. The system of any of Aspects 11 to 14, wherein the facility comprises a well pumping system configured to extract materials from a downhole of a well.

Aspect 16. The system of any of Aspects 11 to 15, wherein the machine learning model is configured to infer operations of a well drilling system at the facility.

Aspect 17. The system of any of Aspects 11 to 16, wherein the processor is configured to execute the instructions and cause the processor to: identify a solution corresponding to the at least one root cause based on the n-grams.

Aspect 18. The system of any of Aspects 11 to 17, wherein the processor is configured to execute the instructions and cause the processor to: identify an equipment associated with at least one of the solution or the root cause based on the unique identifier of the facility.

Aspect 19. The system of any of Aspects 11 to 18, wherein the machine learning model is configured to receive runtime information, identify at least one condition based on the runtime information, and output a notification related to the at least one condition.

Aspect 20. The system of any of Aspects 11 to 19, wherein the full name comprises a unique identifier, information pertaining to equipment at the facility is stored in a data source and includes the unique identifier, reliability reports and unstructured information associated with the facility and stored in the data source include the unique identifier, and time series data associated with measurements from the equipment at the facility stored in the data source include the unique identifier.

Aspect 21. A non-transitory computer-readable storage medium comprising instructions stored thereon which, when executed by at least one processor, causes the at least one processor to perform operations according to any of Aspects 1 to 10.

Aspect 22. An apparatus for calibrating reliability records comprising one or more means for performing operations according to any of Aspects 1 to 10.

What is claimed is:

1. A method of calibrating reliability records, comprising:
receiving a reliability report and extracting information related to operation of equipment at a facility;
extracting name information associated with the facility from the reliability report;
determining a full name of the facility based on the name information; and
training a machine learning model to identify operating conditions for equipment at the facility based on the reliability report, the unique identifier, and the full name of the facility.

2. The method of claim 1, wherein the unique identifier includes the name information, and wherein the name information matches at least one other unique identifier.

3. The method of claim 1, wherein extracting the information related to the operation of the equipment at the facility:
extracting n-grams from a free-form text field associated with the reliability report; classifying the operation of the facility based on labels applied to the n-grams into at least one classification; and
determining at least one source associated with an adverse operating condition of an equipment at the facility based on the at least one classification.

4. The method of claim 3, further comprising:
labeling the n-grams with a plurality of labels based on a second machine learning model, wherein the labels include at least one of properties associated with the equipment at the facility, physical properties of materials, or geographical properties associated with facility.

5. The method of claim 4, wherein the facility comprises a well pumping system configured to extract materials from a downhole of a well.

6. The method of claim 4, wherein the machine learning model is configured to infer operations of a well drilling system at the facility, and wherein the well drilling system is installed into a well at the facility.

7. The method of claim 3, further comprising:
identifying a response corresponding to the at least one source associated with the adverse operating condition based on the n-grams.

8. The method of claim 7, identifying an equipment associated with at least one of the response or the root cause based on the unique identifier of the facility.

9. The method of claim 1, wherein the machine learning model is configured to receive runtime information, identify at least one condition based on the runtime information, and output a notification related to the at least one condition, and

10. The method of claim 1, wherein the full name comprises a unique identifier, information pertaining to equipment at the facility is stored in a data source and includes the unique identifier, reliability reports and unstructured information associated with the facility and stored in the data source include the unique identifier, and time series data associated with measurements from the equipment at the facility stored in the data source include the unique identifier.

11. A system for calibrating reliability records, comprising:
a storage configured to store instructions;
a processor configured to execute the instructions and cause the processor to:
receive a reliability report and extract information related to operation of equipment at a facility;
extract name information associated with the facility from the reliability report;
determine a full name of the facility based on the name information; and
train a machine learning model to identify adverse conditions for equipment disposed in a well environment based on the reliability report, the unique identifier, and the full name of the facility.

12. The system of claim 11, wherein the unique identifier includes the name information, and wherein the name information matches at least one other unique identifier.

13. The system of claim 11, wherein the processor is configured to execute the instructions and cause the processor to:
extract the information related to the operation of the equipment at the facility;
extract n-grams from a free-form text field associated with the reliability report;
classify the operation of the facility based on the n-grams into at least one classification; and
determine at least one source associated with an adverse operating condition of an equipment at the facility based on the at least one classification.

14. The system of claim 13, the processor is configured to execute the instructions and cause the processor to:
label the n-grams with a plurality of labels based on a second machine learning model, wherein the labels include at least one of properties associated with the equipment at the facility, physical properties of materials, or geographical properties associated with facility.

15. The system of claim 14, wherein the facility comprises a well pumping system configured to extract materials from a downhole of a well.

16. The system of claim 14, wherein the machine learning model is configured to infer operations of a well drilling system at the facility, and wherein the well drilling system is installed into a well at the facility.

17. The system of claim 13, wherein the processor is configured to execute the instructions and cause the processor to:
identify a response corresponding to the at least one source associated with the adverse operating condition based on the n-grams.

18. The system of claim 17, wherein the processor is configured to execute the instructions and cause the processor to:
identify an equipment associated with at least one of the solution or the root cause based on the unique identifier of the facility.

19. The system of claim 11, wherein the machine learning model is configured to receive runtime information, identify at least one condition based on the runtime information, and output a notification related to the at least one condition.

20. A well drilling comprising:
a storage medium comprising a machine learning model configured to infer operating conditions from a plurality of reliability reports, wherein the reliability reports are generated based on a maintenance associated with at least one equipment;
a network interface; and
a processor configured to execute instructions and cause the processor to:
receive measurements from equipment located at a facility;
identify at least one notification pertaining to operating conditions of the equipment based on the machine learning model and a location of the facility; and
send the at least one notification to a client device.
